(19) United States
(12) Patent Application Publication
(10) Pub. No.: US 2007/0255188 A1
(43) Pub. Date: Nov. 1, 2007

(54) Massager

(76) Inventor: Jung-Chun Tseng, Taoyuan City (TW)

Correspondence Address: TROXELL LAW OFFICE PLLC, SUITE 1404, 5205 LEESBURG PIKE, FALLS CHURCH, VA, 22041, US

(21) Appl. No.: 11/414,334

(22) Filed: May 1, 2006

(51) Int. Cl. A61H 19/00; A61H 7/00

(52) U.S. Cl. 601/94; 601/93

(57) ABSTRACT

A massager includes a power unit to drive two compression plates linked to two axial seats to relatively swing for kneading on the neck of the user; a kneading unit being each provided externally to the plate; one or a plurality of dancer driven by a transmission shaft being disposed to each kneading unit to provide continuous movement simulating finger pressing to massage the user's neck and shoulders at the same time.

### BACKGROUND OF THE INVENTION

(a) Field of the Invention

The present invention is related to a massager, and more particularly, to a power massager that respectively provides kneading and finger pressing massage effects upon the neck and shoulders of the user.

(b) Description of the Prior Art

Whether due to excessive pressure from making a living, or long hours of continuous reading or working in improper postures, it's not uncommon for people today to complaint about sour and stiff neck and shoulders. Whereas there are so many causes explaining sour shoulders, therapeutic methods also vary. Wherein, proper massaging should be so far the most direct and effective way to mitigate sour, stiff neck and shoulders. After proper massage, the condition including systolic pressure, poor circulation, and involuntary contraction and/stretch taut of the muscle can be significantly improved while facilitating metabolism of the accumulation of substances that cause pain to avoid malicious cycling of pain.

Actually the idea of mitigating one's physique and eliminating fatigue by massage is originated from the teaching of Chinese herbal medicine that defines the massage as movement to press and knead at the same time to guide and raise the energy. In practice, a practitioner uses his/her skill of pressing and touching or instructs the subject receiving the treatment to execute mild exercise for joints and muscles in general to improve local circulation system or general mechanism. However, as the distribution of muscle tissues and nerve centers, skills and methods to massage a particular part of a human body do vary. So far, those kneading and rolling massagers generally available in the market essentially operate on mechanical transmission to simulate the kneading and pressing motions executed by human fingers and palms to massage the neck of the human body.

However, sour shoulders needs to be mitigated by proper finger pressing to release the tension from the still shoulders. The massager kneading on the neck is insufficient to meet the release of the tension and pains from the neck and the shoulders at the same time.

### SUMMARY OF THE INVENTION

The primary purpose of the present invention is to provide a power massager to achieve the purpose of simulating the kneading and finger pressing motions upon one's neck and both shoulders at the same time. To achieve the purpose, the present invention is comprised of a power unit to drive two plates linked to two axial seats to relatively swing for kneading on the neck of the user; a kneading unit is each provided externally to the plate; and one or a plurality of dancer driven by a transmission shaft is disposed to each kneading unit. Accordingly as driven by the same power unit, both compression plates to massage the neck of the user and two kneading units to massage both shoulders of the user operate synchronously to provide continuous movement simulating finger pressing to massage the user's neck and shoulders at the same time.

### BRIEF DESCRIPTION OF THE DRAWINGS

FIG. 1 is a perspective view of the present invention.

FIG. 2 is an exploded view of the present invention.

FIG. 3 is a sectional view of a power unit in the prevent invention.

FIGS. 4(A) and 4(B) are sectional views showing a construction of a compression plate in the present invention.

FIG. 5 is a blowup view of the compression plate and kneading unit in the present invention.

FIG. 6 is a perspective view of the compression plate and the kneading unit in the present invention.

FIG. 7 is a schematic view showing an operating status of the present invention.

FIG. 8 is a perspective view of a finger-pressing unit in the present invention.

FIG. 9 is a perspective view of a roller in the present invention.

### DETAILED DESCRIPTION OF THE PREFERRED EMBODIMENTS

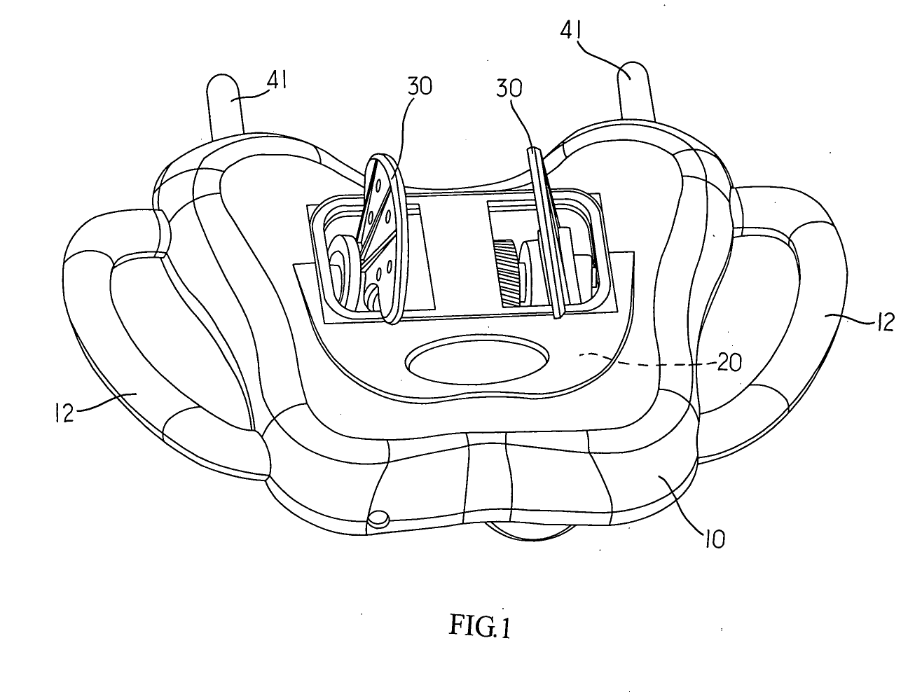

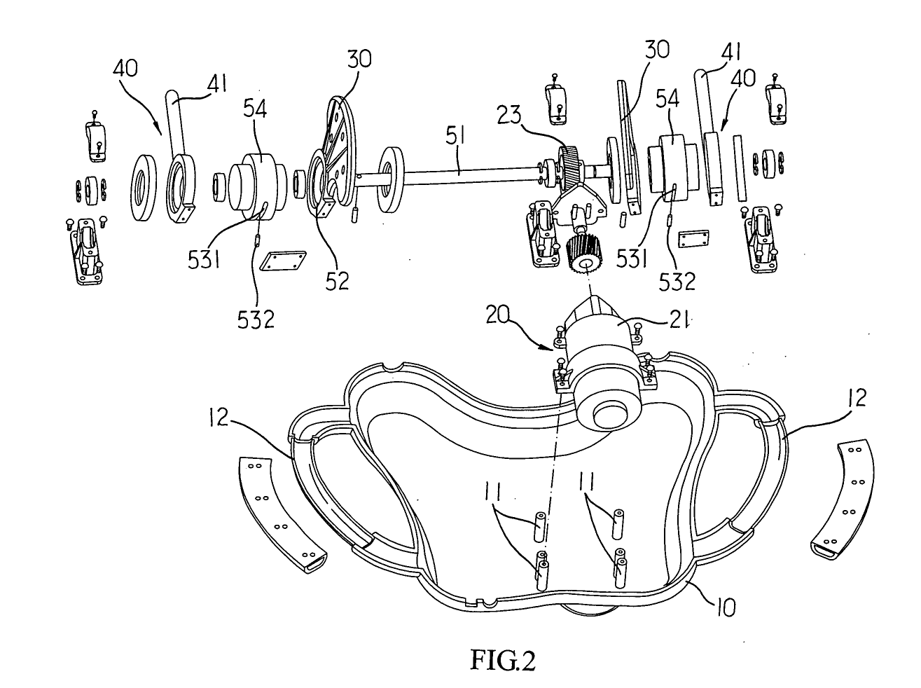

Referring to FIGS. 1 and 2, a preferred embodiment of the present invention is essentially comprised of a casing 10, a power unit 20, two axial seats 54, two compression plates 30, two kneading units 40, and a transmission shaft 51.

The casing 10 relates to the primary mechanical structure for the assembly of all associate units of the massager of the present invention. A locking portion 11 comprised of multiple studs is provided at where specified in the casing 10, and a pair of handles 12 are respectively provided to both sides of the casing 10 for the user to grip.

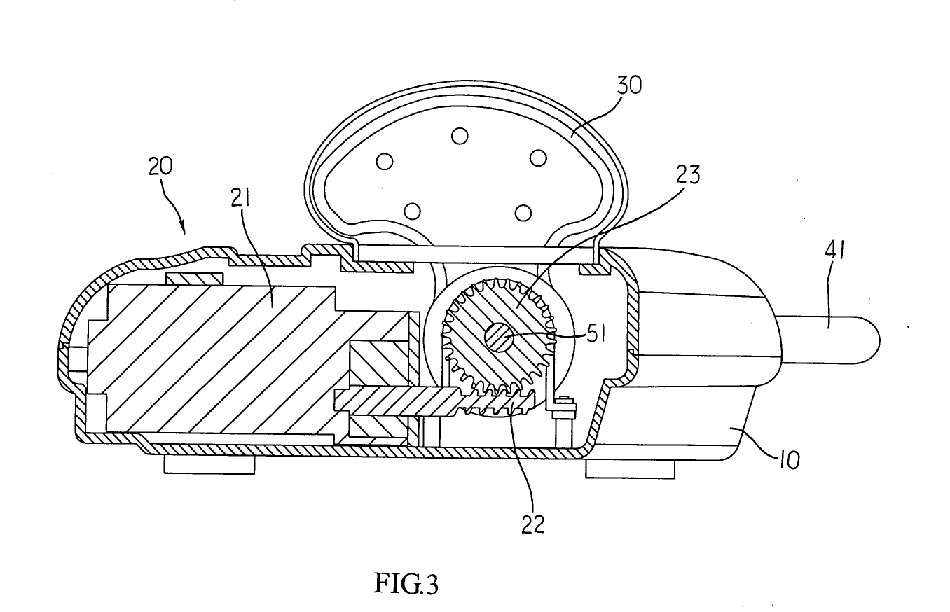

As illustrated in FIGS. 2 and 3, the power unit 20 includes a motor 21 to drive a transmission shaft 51 to rotate. In practice, the spindle of the motor 21 is connected to an active worm gear 22, and the transmission shaft 51 is connected to a passive gear 23 meshed to the active worm gear 22. The motor 21 drivers the transmission shaft 51 disposed at 90 degrees to the spindle of the motor 21 to rotate due to the transmission by both of the active worm gear 22 and the passive gear 23.

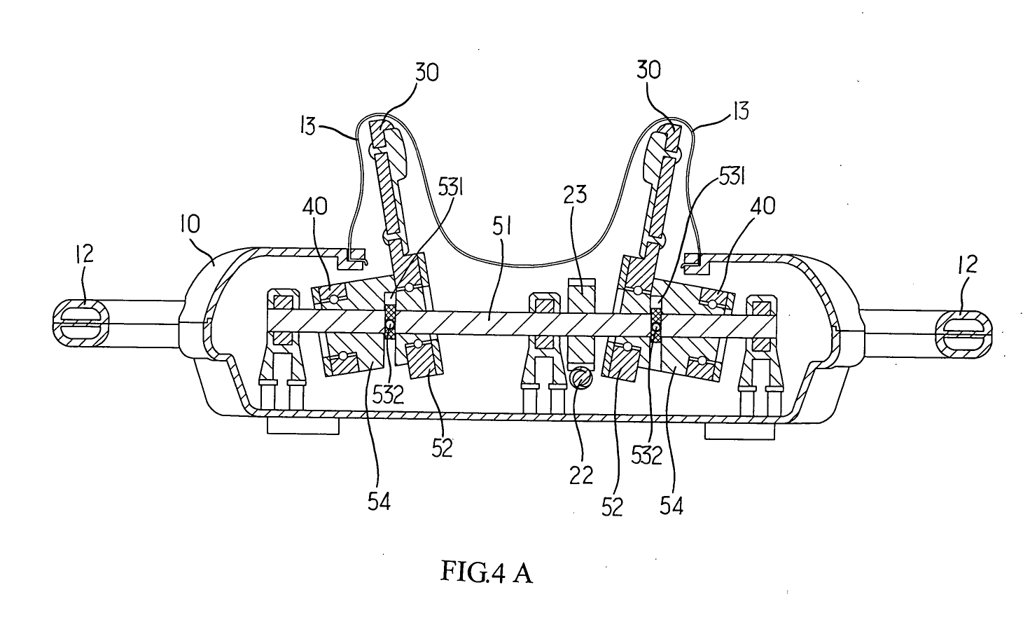

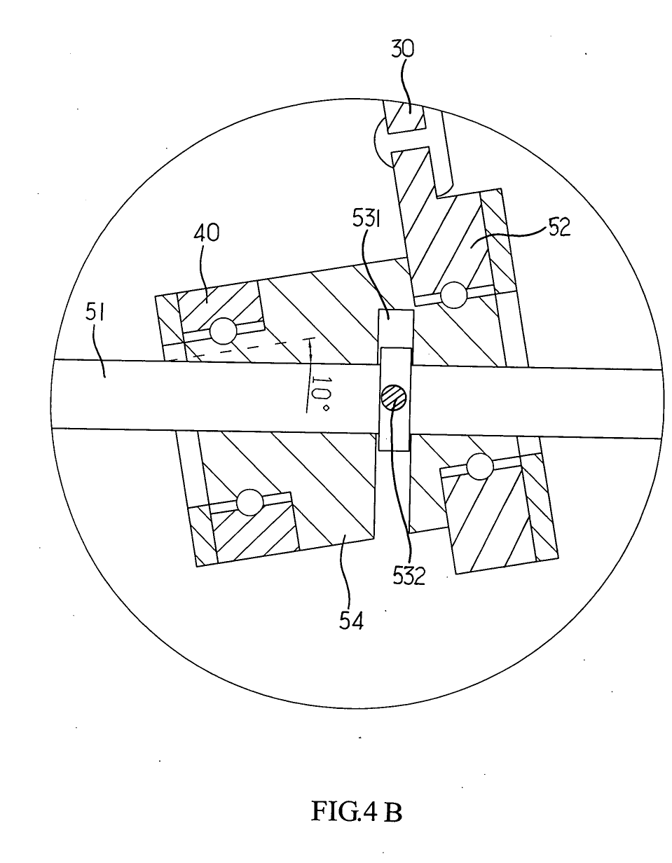

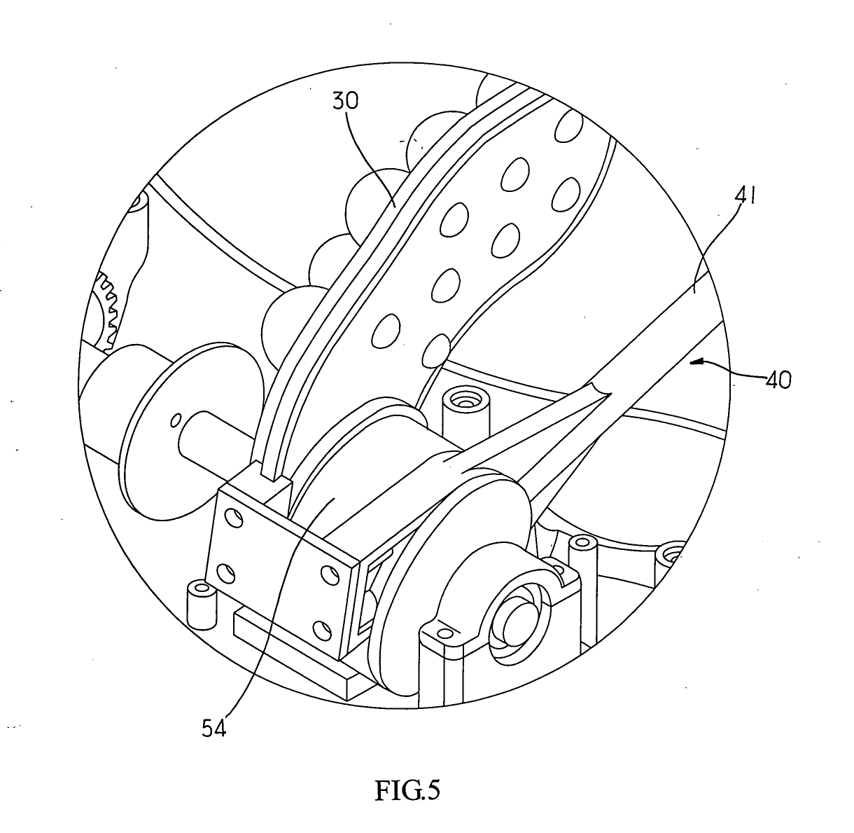

When the transmission shaft 51 is driven by the power unit 20 to further drive the axial seat 54 to rotate as illustrated in FIGS. 4(A), 4(B), and FIG. 5, the axis of the axial seat deflects for a certain inclination laterally from one side to another side for the axial seat 54 to indicate an inclined status with a larger end and a smaller end, and to define a direction shift unit towards where a pin 532 of the transmission shaft 51 is located. According to the preferred embodiment illustrated in FIG. 5, each of both axial seats 54 contains a compression plate 30, and a kneading unit 40 is disposed externally to the axial seat 54 and at a different angle from that of the compression plate 30.

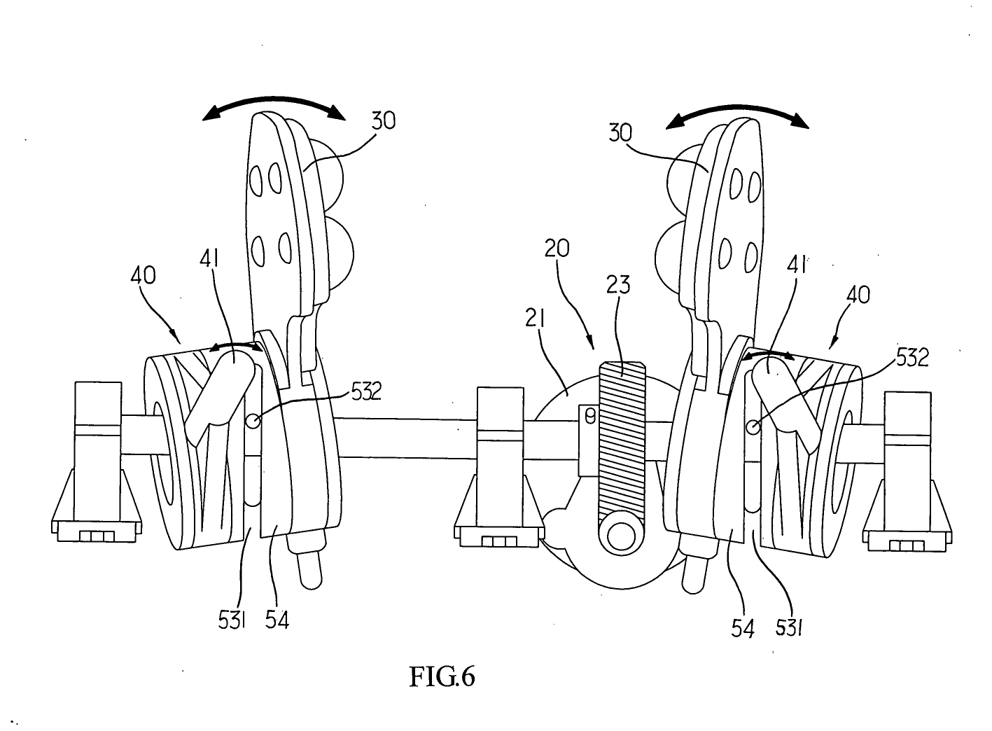

Both compression plates 30 are coupled to each other respectively by means of an oblique disk 52 and the transmission shaft 51 as illustrated in FIGS. 2 and 4. Wherein, a direction shift unit disposed to one axial seat 54 contains a 180-degree groove 531 for the transmission shaft 51 to be coupled to the axial seat 54 by inserting the pin 532 into the groove 531. As illustrated in FIG. 6, when the transmission shaft 51 is driven by the direction shift unit to engage in 180-degree reciprocal motion, the compression plate 30 is driven by the revolving oblique disk 52 to reciprocally swing for both compression plates 30 to alternatively clamp and release at the same time. Accordingly, both compression plates 30 knead the neck of the user, or manipulate the neck by having both compression plates to operate in parallel using the direction shift unit.

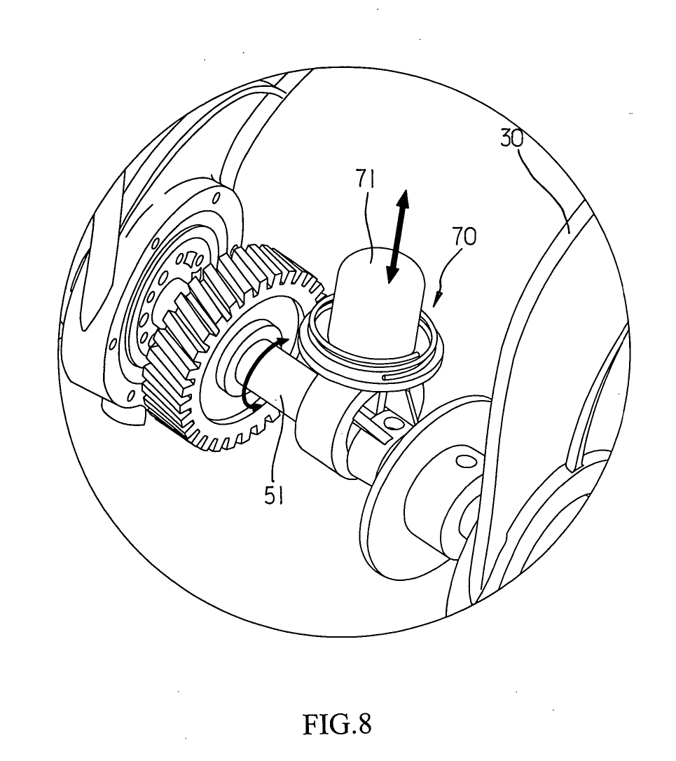

Both kneading units 40 are respectively disposed externally to both compression plates 30. In the preferred embodiment, the knead unit 30 is substantially located at a right angle to the compression plate 30. As illustrated in FIGS. 5 and 6, each kneading unit 40 is provided with one or a plurality dancer 41 swinging continuously when driven by the transmission shaft 51. In practice, two axial seats 54 are respectively provided on both sides of the transmission shaft. To the inner side of each axial seat 54, the compression plate is provided; and on the outer side to the axial seat 54, the kneading unit 40 is provided at an angle different from that of the compression plate 30 in relation to the transmission shaft 51. The axis of the axial seat 54 has a deflection at a certain angle (10 degrees in the preferred embodiment) laterally leaning from one side to the other side for the axial seat 54 to stay in an inclined status with one end indicating larger and the other end, smaller. When the transmission 51 turns, it drives both compression plates 30 to either engaging in swinging to clamp or to release, or in parallel motion to massage the user's neck while driving the kneading units 40 to massage user's shoulders. Furthermore, as illustrated in FIG. 8, a finger-pressing unit 70 disposed with one or a plurality of hammer 71 is provided at the center of the transmission shaft 51 to simulate continuous finger-pressing motion when driven by the transmission shaft 51.

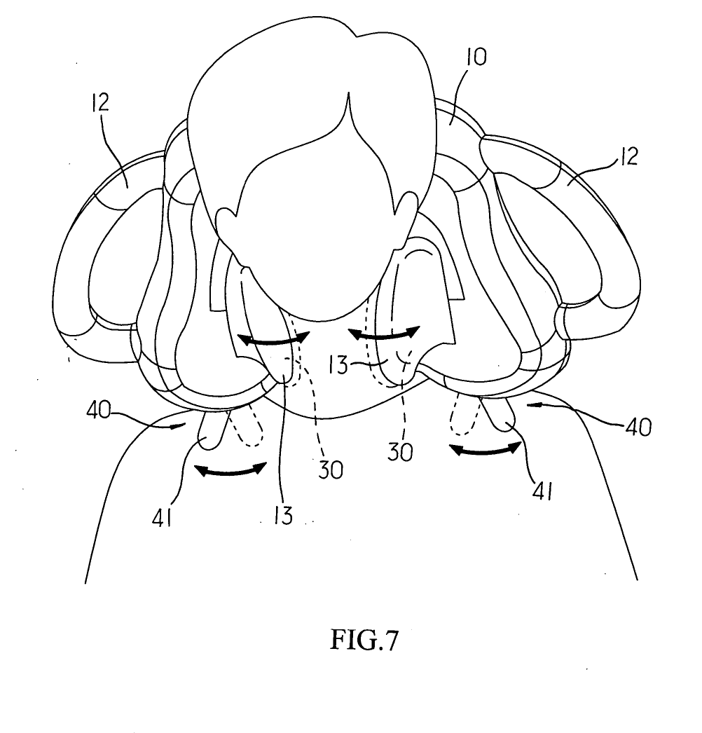

Accordingly, as driving by the same power unit 20, both compression plates 30 working on the neck of the user and both kneading units 40 working on the shoulders of the user operate synchronously to massage the neck and the shoulders of the user by simulating kneading and rubbing of human hands as illustrated in FIG. 7. As illustrated in FIG. 8, the hammer 71 form the finger-pressing unit 70 separately disposed at the center of the transmission shaft 50 operates as a piston to manipulate the shoulders and the spine of the user both dancers 41 are kneading as driven by the power unit 20. Furthermore, as illustrated in FIGS. 4 and 7, a resilient jacket 13 covers up both compression plates 30 to increase operating safety and comforts.

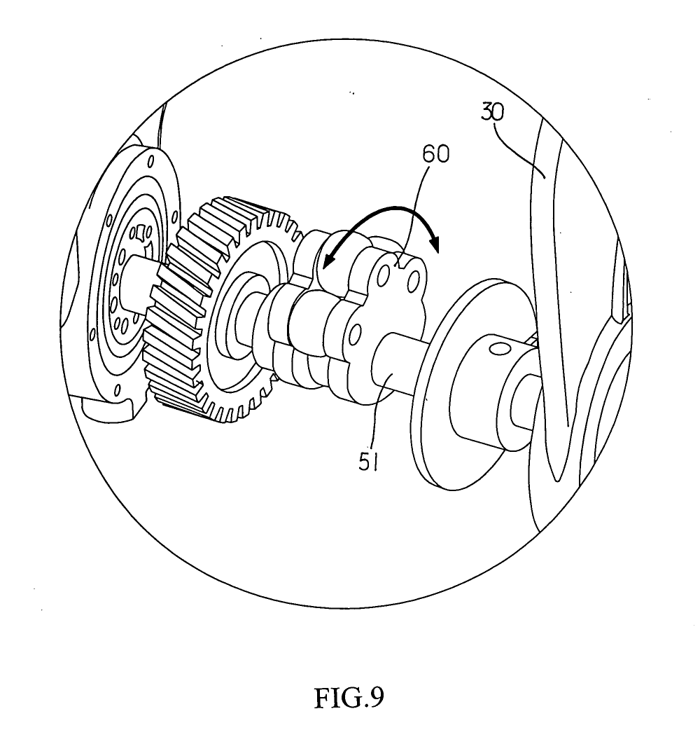

A roller 60 in a construction similar to that of a cam as illustrated in FIG. 9 is further disposed to the transmission shaft 51 at where closer to the center of the transmission shaft 51 to massage the spine of the user.

The prevent invention provides an improved structure of a power massager to release tension from one's neck and shoulders at the same time, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I Claim:

1. A massager includes a casing containing a power unit, the power unit driving two axial seats to operate; the axis of the axial seat laterally deflects at a certain angle of inclination from one end to the other end; each axial seat being disposed with a compression plate on one side and a kneading unit on the other side; both of the kneading units and the compression plate being disposed at different angles from each other; two compression plates being relatively swinging; and both kneading units being driven at the same time to simulate kneading massage by human hands.

2. The massager of claim 1, wherein a locking unit comprised of multiple studs is disposed at preset locations on the inner side of the case to secure their corresponding components of the massager.

3. The massager of claim 1, wherein the power unit includes a motor to drive the transmission shaft to turn; the spindle of the motor is connected to an active worm gear; and a passive gear meshed to the active worm gear is connected to the transmission shaft.

4. The massager of claim 1, wherein both compression plates are respectively-coupled to the transmission shaft by means of an oblique disk.

5. The massager of claim 1, wherein both compression plates are respectively coupled to the transmission shaft by means of an oblique disk; a direction shift unit is disposed at where between the oblique disk of one compression plate and the transmission shaft; and a 180-degree groove being disposed to the direction shift unit; the transmission shaft is coupled to the direction shift unit by having a pin inserted into the groove.

6. The massager of claim 1, wherein both kneading units are respectively disposed at where externally to both compression plates; each kneading unit is provided with one or a plurality of dancer to continuously swing when driven by the transmission shaft; and the kneading unit is located at where substantially at a right angle to the compression plate.

7. The massager of claim 1, wherein a resilient jacket is provided to the casing to cover up both compression plates.

8. The massager of claim 1, wherein a roller is disposed at where closer to the center of the transmission shaft.

9. The massager of claim 1, wherein a finger-pressing unit is disposed at the center of the transmission shaft; the roller is disposed with one or a plurality of hammer; and the hammer is driven by the transmission shaft to engage in continuous motion of simulating finger-pressing manipulation.
